(19) United States
(12) Patent Application Publication
(10) Pub. No.: US 2026/0169857 A1
(43) Pub. Date: Jun. 18, 2026

(54) Cross-Shelf Data Replication

(71) Applicant: NetApp, Inc., San Jose, CA (US)

(72) Inventors: Sumith Makam, Bangalore (IN); Ananthan Subramanian, San Ramon, CA (US); Richard Parvin Jernigan, IV, Sewickley, PA (US); Tijin George, San Jose, CA (US)

(73) Assignee: NetApp, Inc., San Jose, CA (US)

(21) Appl. No.: 18/980,516

(22) Filed: Dec. 13, 2024

(51) Int. Cl. G06F 11/14; G06F 11/20

(52) U.S. Cl. CPC G06F 11/1435; G06F 11/2033; G06F 11/2056

(57) ABSTRACT

The disclosure describes systems, devices, and methods for replicating metadata in data storage environments. In an example embodiment, a method for operating a controller in a data storage environment to provide cross-shelf data replication is provided. In performing the method, the controller generates metadata for an input/output (I/O) request upon receiving the I/O request. The controller identifies a primary location at which to store the metadata and identifies a secondary location at which to store a replicated version of the metadata, then stores the metadata at the primary location and the replicated version at the secondary location. The primary and secondary locations correspond to storage devices in the data storage environment located on different physical shelves or enclosures, such that the metadata is stored across multiple drive shelves for redundancy and recovery purposes.

### TECHNICAL FIELD

Embodiments of the present disclosure relate generally to data storage technology, and in particular, to data back-up and recovery in data storage contexts.

### BACKGROUND

A typical architecture of a data storage environment includes a host device, a controller, and a storage aggregate including numerous storage devices capable of storing data. The host device interfaces with users to receive input/output requests for accessing the storage devices, and the host device communicates the input/output requests to the controller. The controller then interfaces with the storage devices to access locations in the storage devices specified in the input/output requests. The input/output requests refer to read operations, in which the controller reads data from the storage devices, and write operations, in which the controller writes data to the storage devices.

Often, in data storage environments, the storage devices are located together on a drive shelf or rack that physically holds all the storage devices together. Multiple drive shelves may be included in an environment, each holding a subset of the storage devices. Upon storing data to the storage devices of a drive shelf, the controller manages metadata that includes information about the data, the storage devices, and the location at which the data is stored on the storage devices, including which storage device and drive shelf maintains the data. Importantly, the metadata provides a mapping of all the storage devices and data stored thereon. Problematically, when a drive shelf fails rendering all storage devices thereof unavailable, not only is data stored on the storage devices of the failed drive shelf lost, but also metadata associated with the drive shelf and correlating data distributed across multiple data shelves may be lost.

To improve robustness against data and metadata loss, some data storage environments employ replication solutions at the storage aggregate level. More specifically, storage aggregate-level solutions replicate the entire storage system, including user data and metadata between two storage systems in different locations. However, these solutions are costly as two different storage systems must be maintained and synchronized. Other replication solutions may duplicate user data and metadata at a volume level. While these solutions are less expensive than storage aggregate-level solutions, these solutions introduce performance degradation issues as each I/O request must be duplicated in real-time to maintain data consistency between multiple storage volumes.

### SUMMARY

The technology described herein utilizes selective data replication techniques to improve robustness, redundancy, and resiliency of metadata in data storage environments. In particular, metadata corresponding to I/O operations and associated data (stored on one drive shelf of a data storage environment is replicated to a different drive shelf to reduce loss vulnerability in cases of drive shelf failure. Thus, if one drive shelf fails, the replicated metadata can be accessed at another location in the data storage environment.

In an implementation, a method for operating a controller in a data storage environment to provide cross-shelf data replication is provided. In performing the method, the controller generates metadata for an input/output (I/O) request upon receiving the I/O request. The controller identifies a primary location at which to store the metadata and identifies a secondary location at which to store a replicated version of the metadata, then stores the metadata at the primary location and the replicated version at the secondary location. The primary and secondary locations correspond to storage devices (may also be referred to as “drives”) in the data storage environment located on different physical shelves or enclosures, such that the metadata is stored across multiple drive shelves for redundancy and recovery purposes.

This overview is provided to introduce a selection of concepts in a simplified form that are further described below in the technical disclosure. It may be understood that this Overview is not intended to identify key features or essential features of the claimed subject matter, nor is it intended to be used to limit the scope of the claimed subject matter. These and other features and aspects of various examples may be understood in view of the following detailed discussion and accompanying drawings.

### BRIEF DESCRIPTION OF THE DRAWINGS

For a more complete understanding of the present invention(s), and the advantages thereof, reference is now made to the following descriptions taken in conjunction with the accompanying drawings.

FIG. 1 illustrates an example operating environment in an implementation.

FIG. 2 illustrates a method for replicating metadata across drive shelves of a data storage environment in an implementation.

FIG. 3 illustrates an example operational sequence of replicating metadata across drive shelves of a data storage environment in an implementation.

FIG. 4 illustrates an example data storage system in an implementation.

FIG. 5 illustrates an example data storage system in an implementation.

FIG. 6 illustrates an example aspect of metadata used in an implementation.

FIG. 7A illustrates an example operating environment in an implementation.

FIG. 7B illustrates an example operating environment in an implementation.

FIG. 8A illustrates an example data storage environment in an implementation.

FIG. 8B illustrates an example metadata table used in an implementation.

FIG. 9 illustrates a computing system suitable for implementing the various systems, operational environments, architectures, environments, methods, processes, scenarios, sequences, and frameworks discussed below with respect to the other Figures.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Technology is disclosed herein that mitigates the problems discussed above with respect to data replication in existing data storage environments by utilizing a selective metadata replication process in which file system metadata (e.g., Write-Anywhere File Layout (WAFL) system metadata) is replicated across different drive shelfs ensuring data availability despite drive shelf failures. A WAFL type storage operating system does not rewrite a block, but instead, allocates a new block for each rewrite operation, i.e. a new block is allocated for each write operation. The various aspects disclosed herein are not limited to any specific file system type and can be implemented by other file systems and storage operating systems.

The selective metadata replication processes may be utilized in both one-to-one data storage architectures, in which each controller in a data storage environment accesses a specific subset of storage devices in the data storage environment but does not interface with nor control other subsets of storage devices, and shared-everything data storage architectures, in which each controller is capable of accessing any storage device. In a shared-everything architecture, a single pool of storage devices (referring interchangeably to the terms storage device, disk, and drive) may be utilized for an entire cluster of controllers (referring interchangeably to the terms controllers and nodes) with equal and common access to the storage devices by the controllers.

In either arrangement, the storage devices in the data storage environment are collectively referred to as a storage aggregate where each aggregate is identified by a unique identifier and a location. Within each aggregate, one or more storage volumes are created whose size can be varied. A qtree, sub-volume unit may also be created within the storage volumes. Each storage volume can be configured to store data containers (e.g. files, directories, structured or unstructured data, or data objects), scripts, executable programs, and any other type of data. From the perspective of a client system, each volume can appear to be a single drive. However, each volume can represent storage space at one storage device, an aggregate of some or all the storage space in multiple storage devices, a RAID group (e.g., sets of drives or disks providing RAID functionality, where RAID stands for Redundant Array of Independent Disks), or any other suitable set of storage space. The storage aggregate is divided into multiple RAID groups (e.g., sets of drives or disks providing RAID functionality, where RAID stands for Redundant Array of Independent Disks), and each RAID group includes one or more data disks and one or more parity disks that provide redundancy with respect to each other. The arrangement of the RAID groups, and the storage devices in each RAID group, is referred to as the aggregate layout.

In various examples, the disks are enclosed in one or more drive shelves that hold a number of disks (e.g., 24 disks). Each drive shelf functions independently with respect to power and network connectivity. For example, each drive shelf includes its own power supply to power the disks and an interconnect to connect the disks to a network by which the controller(s) access the disks. In some such examples, each drive shelf includes one or more RAID groups. Some RAID groups may span multiple drive shelves.

In defining the aggregate layout, in shared-everything architectures, each controller in the data storage environment may be allocated a range of blocks (e.g., logical or physical address spaces) on each storage device across all the storage devices within the same RAID group (the blocks across all the storage devices being referred to as a stripe). This allows each controller to write in parallel to the same set of storage devices without corrupting each other's data. The ownership of such ranges by individual controllers is tracked in filesystem (e.g., WAFL) metadata stored on one or more of the storage devices in the aggregate. Problematically, a single pool of storage in shared-everything architectures requires the aggregate to encompass all the disks in the cluster, which consequently requires the same metadata to be referred to by all the storage devices. For such a cluster, potentially hundreds of controllers may need to access and rely upon the same metadata. Problematically, upon failure of a drive shelf, and consequently, loss of access to data of a RAID group, a single controller might not be able to reconstruct the entire drive without coordinating with other controllers and without consulting the filesystem metadata due to the ownership of block ranges being distributed across all the controllers in the cluster. This poses a significant challenge for the drive reconstruction process as it becomes cluster-wide.

To solve the above problem, systems, devices, and methods disclosed herein utilize replicate data across different shelves, and in some cases also different RAID groups, to ensure metadata availability upon drive shelf failures. For example, the present disclosure describes selectively replicating data so that replicated data can be read in case of any media or drive errors causing the primary metadata to be lost. The replication of aggregate metadata can prevent system failures when encountering bad blocks. The replication also allows a graceful termination of operations without affecting the entire system. This is helpful in handling critical system messages that cannot be aborted without significant complications, such as during a checkpoint process. This solution is also beneficial for addressing checksum errors or lost write errors in a few blocks when a drive shelf or RAID groups is in a degraded state, for example, when two disks are flagged as faulty in a RAID DP configuration. As such, the solution ensures that the storage aggregate (i.e., other non-failed drive shelves) remain available even in the event of disk one shelf failures.

To facilitate access to storage space, a controller implements a file system that logically organizes stored information as a hierarchical structure for files/directories/objects at the storage devices. Each “on-disk” file can be implemented as a set of data blocks configured to store information, such as text, whereas a directory can be implemented as a specially formatted file in which other files and directories are stored. The data blocks are organized within a volume block number (VBN) space that is maintained by the file system. The file system may also assign each data block in the file a corresponding “file offset” or file block number (FBN). The file system typically assigns sequences of FBNs on a per-file basis, whereas VBNs are assigned over a larger volume address space. The file system organizes the data blocks within the VBN space as a logical volume. The file system typically may include a contiguous range of VBNs from zero to n, for a file system of size n−1 blocks. When accessing a block of a file in response to an input/output request, the file system specifies a VBN that is translated at the file system/RAID system boundary into a physical volume block number (“PVBN”) location on a particular storage device (storage device, PVBN) within a RAID group of the physical volume).

The file system maintains a buffer tree as an internal representation of blocks for a file stored in a buffer cache of a memory of a controller. Broadly stated, the buffer tree has an inode at the root (top-level) of the file. An inode is a data structure used to store information, such as metadata, about a file, whereas the data blocks are structures used to store the actual data for the file. The information in an inode may include, e.g., ownership of the file, file modification time, access permission for the file, size of the file, file type and references to locations on storage devices of the data blocks for the file. The references to the locations of the file data are provided by pointers, which may further reference indirect blocks that, in turn, reference the data blocks, depending upon the amount of data in the file. Each pointer can be embodied as a VBN to facilitate efficiency among the file system and the RAID system when accessing the data.

Volume information (“volinfo”) and file system information (“FSINFO”) blocks (may also be referred to as “super blocks”) specify the layout of information in the file system, the latter block includes an inode of a file with all other inodes of the file system (the inode file). Each logical volume (file system) has an FSINFO block that is preferably stored at a fixed location, e.g., at a RAID group. The inode of the FSINFO block may directly reference (or point to) blocks of the inode file or may reference indirect blocks of the inode file that, in turn, reference direct blocks of the inode file. Within each direct block of the inode file are embedded inodes, each of which may reference indirect blocks that, in turn, reference data blocks (also mentioned as “L0” blocks) of a file.

In existing solutions, a file system may use indirect blocks of metadata to store addresses of primary data blocks (indicative of where actual data is stored). For example, in 64-bit aggregates, each aggregate can store 512 physical volume block numbers (PVBNs), with each indirect block in sequential order from P1 to P512. However, as described herein, the indirect blocks of the metadata are rearranged such that each indirect block is immediately followed by a corresponding protected block (e.g., P1′, P2′, etc.). In this way, the file system metadata is reduced to 256 PVBNs in sequential order but with primary and replicated physical volume block numbers (PVBNs) stored next to each other in pairs of indirect blocks (i.e., P1, P1′, then P2, P2′, and so on). Advantageously, by organizing the metadata such that protected, or replicated, blocks are arranged next to corresponding primary blocks, a controller in the data storage environment can more easily and quickly recover lost data if a primary block fails. Additionally, by storing a protected block next to each primary block, the system can quickly recover from a single point of failure.

Further, under this metadata scheme, the virtual volume buffer tree (or VVOL buftree) format need not be changed. If the PVBN in the VVOL buftree is not readable, the corresponding container can be looked up to get the replicated PVBN. As the paired PVBN protection can be enabled at VVOL, only the selected indirect blocks have to be replicated, though, in some examples, additional buffer tree metadata may also be replicated. When replicating the metadata, a controller determines a primary location at which to store the primary block information and a secondary location at which to store the protected, or replicated, block information. There is no restriction that the primary location (e.g., volume block number) should always be from one drive shelf and the secondary location be from a second shelf. However, it is desirable that both the physical locations associated with the primary and secondary locations (e.g., PVBNs) should be from different disk shelves.

Examples of the metadata to be replicated using such processes includes aggregate metadata and virtual volume metadata (e.g., bitmaps, metafiles). Other virtual volume data specified for replication may also be replicated.

In some examples, this solution further includes copying the protected (e.g., replicated) metadata or data to newly added shelves/disks, after recovering from the shelf failure by replacing a new shelf or failed disks. While having two copies of the blocks may increase the overall cost of managing the data storage environment, the replicated blocks may be tiered out to a cloud platform. These blocks can be dual tier dirtied, without the need for any additional local storage. Whenever these blocks are overwritten, tiered out blocks are overwritten without having to read them from the cloud platform. Today, only user data can be tiered out, but it can be enhanced to tier out metadata as well.

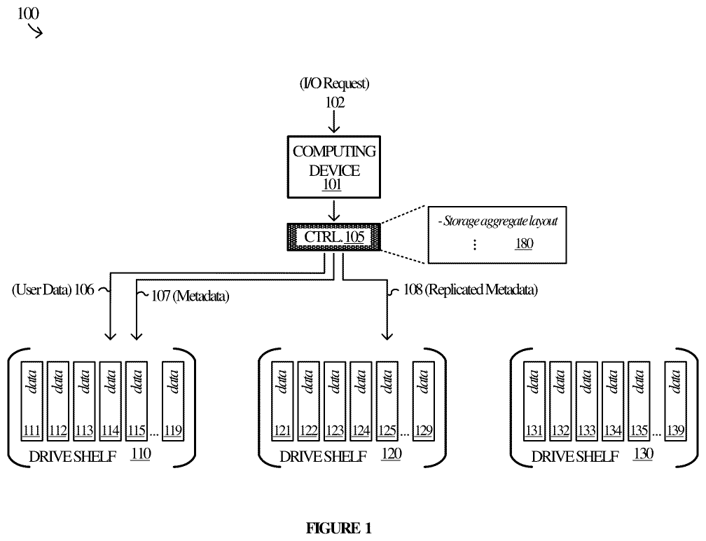

FIGS. 1, 2, 3, 4, 5, 6, 7A, 7B, 8A, and 8B below illustrate and describe additional details of such systems, devices, and methods.

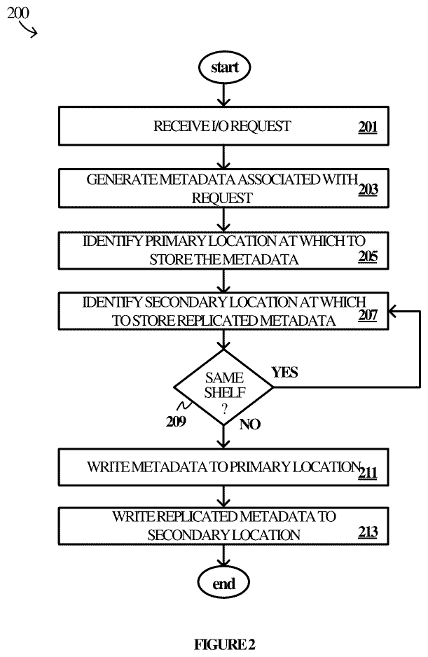

FIG. 1 illustrates operating environment 100 in which elements of a data storage system operate in an implementation. Operating environment 100 includes a computing device (may also be referred to as “host”) 101, controller (may also be referred to as a storage controller, storage system controller) 105, and drive shelves 110, 120, and 130. Drive shelves 110, 120, and 130 may each include a plurality of storage devices (also referred to as drives or disks). In various embodiments, controller 105 is configured to perform data storage and data replication processes, such as method 200 of FIG. 2.

Operating environment 100 is representative of a data storage environment that includes hardware, software, and firmware components capable of storing data, managing access to the data, and managing storage devices, among other functions. In operating environment 100, controller 105 and the storage devices of drive shelves 110, 120, and 130 (also collectively referred to as a storage aggregate) are arranged in an architecture such that controller 105 can access any of the storage devices of the storage aggregate. In particular, controller 105 performs input/output (I/O) operations (e.g., read operations, write operations) with any and all of the storage devices of Drive shelves 110, 120, and 130.

Computing device 101 is representative of one or more host servers, applications, devices, systems, or the like, capable of providing I/O operations to controller. Computing device 101 may include and may be implemented in hardware, software, and/or firmware, as well as combinations and variations thereof.

By way of example, computing device 101 is representative of a server running an application that interfaces with controller 105 via a communication network to read from and write to the storage devices. An end user accesses computing device 101, or the application thereof, via a user device (e.g., a computer, a tablet, a smartphone), and provides requests to perform I/O operations via controller 105 to access the storage devices. computing device 101 Computing device 101 provides the I/O requests to controller 105 using an interface (e.g., a command line interface (CLI)) to the application over an application programming interface (API) (e.g., a RESTful API).

Controller 105 is representative of a control device or system that includes one or more processing devices capable of controlling, managing, and accessing each of the storage devices of operating environment 100. Examples of the processing devices may include one or more central processing units (CPUs), general purpose processors, Application Specific Integrated Circuits (ASICs), microcontroller units (MCUs), digital signal processors (DSPs), field-programmable gate arrays (FPGAs), and the like. In some examples, controller 105 may represent two or more controllers coupled as high availability (HA) pairs for at least fault tolerance and back-up purposes.

In various examples, controller 105 is configured to run an instance a storage operating system (e.g., NetApp ONTAP® (without derogation of trademark rights of NetApp Inc., the assignee of this application)) to perform the I/O operations received from computing device 101. Controller 105 can perform I/O operations using a WAFL type file system whereby controller 105 determines a location at which to write data associated with an I/O operation on-the-fly based on metadata indicative of available storage. Controller 105 interfaces with computing device 101 via the application in accordance with a storage network and access protocol, such as Non-Volatile Memory Express (NVMe). Other protocols such as Network File System (NFS), Server Message Block protocol (SMB), Internet Small Computer System Interface (iSCSI), Fiber Channel (FC), Fiber Channel over Ethernet (FCoE), and the like may be contemplated. Controller 105 may further interface with the storage devices of drive shelves 110, 120, and 130 over one of the network protocols to perform the I/O operations.

Drive shelves 110, 120, and 130 are each representative of a group or array of storage devices physically located in proximity relative to one another in a shelf or enclosure (e.g., a storage shelf, a rack). Examples of the storage devices include flash disks and/or capacity drives, such as hard-disk drives (HDDs) and solid state drives (SSDs), as well as combinations and variations thereof. As illustrated in operating environment 100, drive shelf 110 includes disks 111, 112, 113, 114, 115, and 119, drive shelf 120 includes disks 121, 122, 123, 124, 125, and 129, and drive shelf 130 includes disks 131, 132, 133, 134, 135, and 139 (all collectively referred to as disks, drives, or storage devices).

Drive shelves 110, 120, and 130 additionally include components to power the storage devices, connect drive shelves to a communication network, and the like. For example, drives shelves 110, 120, and 130 each include one or more power supplies, fans, interconnects, network equipment, and the like.

In some embodiments, operating environment 100 may include additional or fewer drive shelves, and each drive shelf may include additional or fewer disks. Additionally, each drive shelf may be made up of one or more redundancy groups of storage devices (e.g. RAID groups), including several data disks and one or more parity disks that each provide redundancy for one another.

In operation, by way of example, computing device 101 receives I/O request 102 corresponding to a write operation of user data 106. Computing device 101 provides I/O request 102 to controller 105. Controller 105 receives the write operation, determines a location at which to write user data 106 (e.g., disk 114), and writes user data 106 to disk 114 of drive shelf 110. Additionally, controller 105 generates metadata 107 for user data 106 and generates a replicated version of metadata 107, replicated metadata 108. Metadata 107 and replicated metadata 108 include information about user data 106 (e.g., file information) and information about the location (e.g., address, e.g., logical block address, physical block address) at which user data 106 is stored. In particular, metadata 107 and replicated metadata 108 may include an index, such as a table or other data structure, which identifies where user data 106 is stored among all the storage devices of operating environment 100.

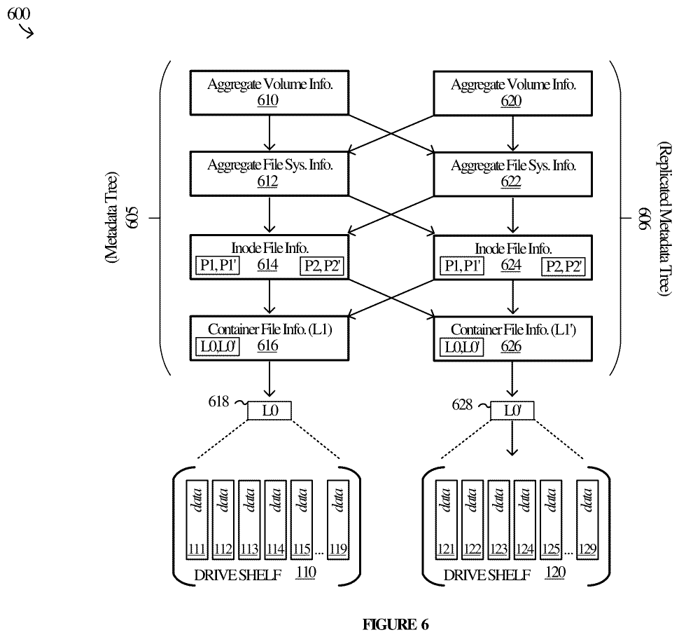

Controller 105 uses metadata 180 to determine locations at which to store metadata 107 and replicated metadata 108. In some examples, metadata 180 may be stored internally relative to controller 105. In some examples, metadata 180 may alternatively, or additionally, be stored in one of the storage devices of operating environment 100 accessible by controller 105. Metadata 180 includes information about the storage aggregate, the storage devices in the storage aggregate and a layout thereof, drive shelf information, physical locations of the storage devices within the storage aggregate and within a particular drive shelf, logical addresses of each of the storage devices, and physical addresses of each of the storage devices relative to the logical addresses, among other information. For example, metadata 180 includes information related to a WAFL aggregate buffer tree, an example of which is provided in FIG. 6 below.

Based on metadata 180, controller 105 determines to store metadata 107 on disk 115 of drive shelf 110 and replicated metadata 108 on disk 125 of drive shelf 120. In particular, controller 105 first identifies an available logical address of disk 115 and determines a physical location (e.g., drive shelf) associated with the logical address of disk 115. Then, controller 105 identifies another available logical address and determines a physical location associated with the other available logical address. Upon determining that the physical locations are different from each other (i.e., the logical addresses correspond to disks on different drive shelves), controller 105 determines to store metadata 107 and replicated metadata 108 at the identified logical addresses of disks 115 and 125, respectively, to avoid storing replicated metadata 108 on the same drive shelf as metadata 107 for redundancy and recovery purposes, for example.

Controller 105 may perform the above processes for all I/O requests, such that metadata associated with given user data is stored in two different physical locations within operating environment 100. Advantageously, by storing metadata and replicated metadata on different physical drive shelves, controller 105 can improve data redundancy and recovery as information is accessible and recoverable elsewhere in the case of drive shelf failures, which may cause all the drives on a failed drive shelf to be unavailable at least temporarily. In some examples, controller 105 may also perform such data replication processes with user data (e.g., user data 106) as well.

Subsequently, or independently of I/O request 102 (write operation), controller 105 may receive an I/O operation corresponding to a read operation of user data 106 stored in the storage aggregate. Upon receiving the I/O operation, controller 105 determines the primary location at which metadata 107 associated with user data 106 is stored, then attempts to read the metadata to determine the location at which user data 106 is stored (disk 114). Based on determining where user data 106 is stored, controller 105 reads user data 106 from disk 114 of drive shelf 110 and provides user data 106 to computing device 101. If, however, controller 105 identifies a failure with disk 115 (e.g., the primary location) when attempting to read from the primary location, controller 105 instead determines the secondary location at which replicated metadata 108 is stored to determine the location at which user data 106 is stored to read user data 106.

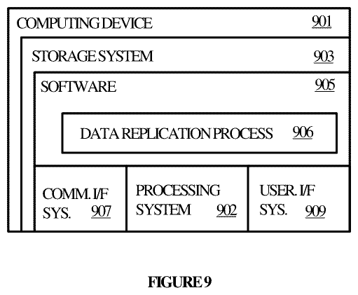

FIG. 2 illustrates method 200 for performing metadata generation, replication, and storage operations in an implementation. Method 200 may be employed by a computing device, such as controller 105 of operating environment 100, an example of which is provided by computing system 901 of FIG. 9. Accordingly, method 200 may be implemented in hardware, software, and/or firmware, and may be implemented in program instructions executable by one or more processors of the computing device. The program instructions direct the computing device to operate in accordance with the steps of method 200, which reference elements of FIG. 1.

To begin, in operation 201, controller 105 receives I/O request 102 from computing device 101. I/O request 102 indicates a write operation and includes user data 106 to be written to one or more storage devices of operating environment 100. Upon receiving I/O request 102, controller 105 determines a location at which to store user data 106 and stores user data 106 at one or more disks of a drive shelf of operating environment 100, such as disk 114 of drive shelf 110.

In operation 203, controller 105 generates metadata 107 associated with I/O request 102. Metadata 107 may include information about user data 106 and information about where user data 106 is stored. Metadata 107 may also associate user data 106 with I/O request 102. Controller 105 further generates a replicated version of metadata 107 referred to as replicated metadata 108.

Next, in operation 205, controller 105 identifies a primary location at which to store metadata 107. The primary location represents a primary disk on a disk shelf and identifies a logical address of the primary disk. The logical address is associated with the physical location of the primary disk, such as to which disk shelf the primary disk belongs. In various examples, identifying the primary location entails identifying an available logical address and identifying a disk associated with the logical address based on metadata 180.

In operation 207, controller 105 identifies a secondary location at which to store replicated metadata 108. The secondary location represents a secondary, or redundant, disk on a disk shelf. The secondary location also includes a logical address of the secondary disk and an association of the logical address and the physical location of the secondary disk. In some examples, identifying the secondary location entails identifying another available logical address and identifying a disk associated with the logical address based on metadata 180. In some examples, identifying the secondary location instead, or additionally, entails identifying an available logical address from a range of logical addresses that correspond to physical locations different from the physical location of the primary location.

In operation 209, controller 105 determines whether the primary location and secondary location correspond to disks on the same drive shelf. In various examples, this entails comparing the physical locations associated with the logical addresses of the primary and secondary locations for a match. If the physical locations match, then controller 105 determines the locations correspond to the same drive shelf, and controller 105 finds a new secondary location as in operation 207. If the physical locations do not match, then controller 105 determines the locations correspond to different drive shelves, and controller 105 proceeds to store metadata 107 and replicated metadata 108.

In the example illustrated by FIG. 1, controller 105 identifies the primary location as disk 115 of drive shelf 110 and the secondary location as disk 125 of drive shelf 120. Accordingly, controller 105 determines that the locations correspond to different drive shelves. As a result, in operation 211, controller 105 writes metadata 107 to disk 115 (the primary location), and in operation 213, controller 105 writes replicated metadata 108 to disk 125 (the secondary location).

Advantageously, controller 105 can improve resiliency of the data storage environment based on replicating metadata and storing the metadata and replicated versions of the metadata on different physical drive shelves, which allows controller 105 to recover lost data and rebuild failed storage devices in the case of a drive shelf failure.

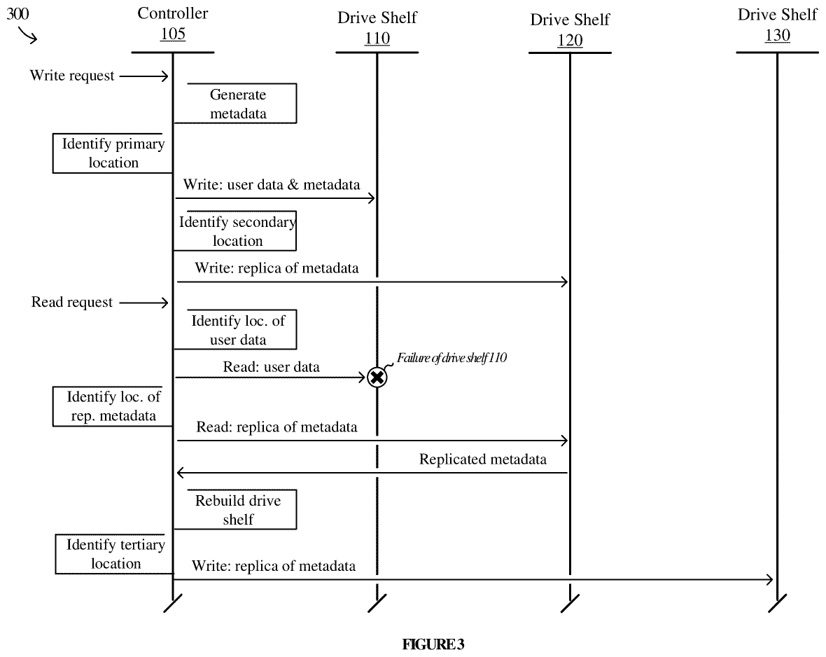

FIG. 3 illustrates operational sequence 300 demonstrative of an example sequence of steps performed by elements of a data storage system, which includes and references elements of operating environment 100. In particular, operational sequence 500 includes steps performed by controller relative to drive shelf 110, drive shelf 120, and drive shelf 130.

To begin operational sequence 300, controller 105 receives a write request from computing device 101 corresponding to a write operation at one or more storage devices of operating environment 100. In response to receiving the write request, controller 105 generates metadata associated with the write request. The metadata may include information about the user data specified in the request and information about where the user data is stored. The metadata may also associate the user data with the particular write request. Controller 105 further generates a replicated version of the metadata.

Next, controller 105 identifies a location at which to write the user data and a primary location at which to store the metadata. The primary location represents a primary disk on a disk shelf and identifies a logical address of the primary disk. The logical address is associated with the physical location of the primary disk, such as to which disk shelf the primary disk belongs. In various examples, identifying the primary location entails identifying an available logical address and identifying a disk associated with the logical address based on storage aggregate layout metadata (e.g., WAFL buffer tree). Controller 105 determines the location at which to store the metadata to be one or more disks of drive shelf 110 and determines the primary location to be a disk of drive shelf 110. Accordingly, controller 105 writes the user data and the metadata to identified disks of drive shelf 110.

Controller 105 also identifies a secondary location at which to store the replicated metadata. The secondary location represents a secondary, or redundant, disk on a disk shelf. The secondary location also includes a logical address of the secondary disk and an association of the logical address and the physical location of the secondary disk. In some examples, identifying the secondary location entails identifying another available logical address and identifying a disk associated with the logical address based on the storage aggregate layout metadata. In some examples, identifying the secondary location instead, or additionally, entails identifying an available logical address from a range of logical addresses that correspond to physical locations different from the physical location of the primary location. Controller 105 determines the secondary location to be a disk of drive shelf 120.

Prior to storing the replicated metadata at the disk of drive shelf 120, controller 105 determines whether the primary location and secondary location correspond to disks on the same drive shelf. In various examples, this entails comparing the physical locations associated with the logical addresses of the primary and secondary locations for a match. If the physical locations match, then controller 105 determines the locations correspond to the same drive shelf, and controller 105 finds a different secondary location. If the physical locations do not match, then controller 105 determines the locations correspond to different drive shelves, and controller 105 proceeds to store the replicated metadata at the secondary location, such as the identified disk of drive shelf 120.

Following completion of the write request, controller 105 receives a read request from computing device 101 corresponding to the user data stored in association with the previous write request. Controller 105 identifies the location of the user data based on reading the metadata stored at the primary location as a result of the previous write request. Controller 105 attempts to read the user data from the one or more disks of drive shelf 110, however, drive shelf 110 has failed, and controller 105 cannot obtain the user data from drive shelf 110.

In response to determining the failure of drive shelf 110, controller 105 identifies the location of the replicated metadata and reads the replicated metadata from drive shelf 120. With the replicated metadata, controller 105 can determine the lost user data, among other lost user data and metadata and can perform recovery operations to rebuild drive shelf 110. While drive shelf 110 undergoes a rebuild, controller 105 may identify a further location at which to store the replicated version of the metadata to ensure redundancy of the metadata in case of a failure of drive shelf 120. Controller 105 identifies a disk of drive shelf 130 as the tertiary location at which to store the replicated metadata and writes the replicated metadata to the disk of drive shelf 130. In some embodiments, controller 105 may instead, or additionally, await the recovery of drive shelf 110, then store the replicated version of the metadata on a drive shelf, or disks of a replacement drive shelf, replacing drive shelf 110.

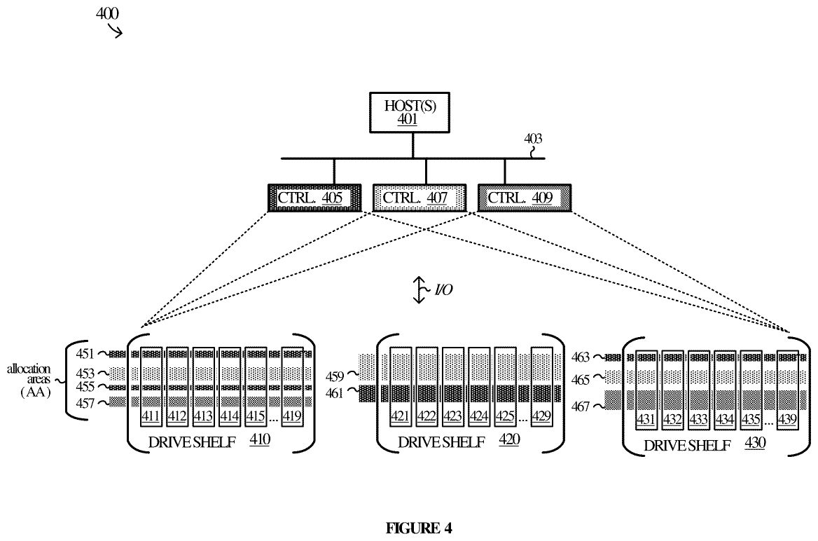

FIG. 4 illustrates an example data storage system in an implementation. FIG. 4 shows system 400, which includes host(s) 401, controllers 405, 407, and 409, and drive shelves 410, 420, and 430. Drive shelves 410, 420, and 430 may each include a plurality of storage devices. In various embodiments, controllers 405, 407, and 409 may be configured to perform data storage and data replication processes, such as method of FIG. 2.

System 400 is representative of a data storage system operating in a data storage environment. System 400 includes multiple controllers and multiple storage devices (e.g., drives) arranged in a shared-everything architecture such that each of the controllers is capable of accessing any of the storage devices. In particular, controllers 405, 407, and 409 can perform input/output (I/O) operations (e.g., read operations, write operations) with all of the storage devices of drive shelves 410, 420, and 430.

Host(s) 401 (hereinafter referred to as host 401) is representative of one or more host servers, applications, devices, systems, or the like, capable of providing I/O operations to controllers 405, 407, and 409. Host 401 may include and may be implemented in hardware, software, and/or firmware, as well as combinations and variations thereof.

By way of example, host 401 is representative of a server running an application that interfaces with system 400 via network 403 to read from and write to the storage devices of system 400. An end user accesses host 401, or the application thereof, via a user device (e.g., a computer, a tablet, a smartphone), and provides requests to perform I/O operations via one of controllers 405, 407, or 409 to access the storage devices. Host 401 provides the I/O requests to controllers 405, 407, and/or 409, using an interface (e.g., a command line interface (CLI)) to the application over an application programming interface (API) (e.g., a RESTful API).

Controllers 405, 407, and 409 are representative of control devices or systems that each include one or more processing devices capable of controlling, managing, and accessing each of the storage devices of system 400. Examples of the processing devices may include one or more central processing units (CPUs), general purpose processors, Application Specific Integrated Circuits (ASICs), microcontroller units (MCUs), digital signal processors (DSPs), field-programmable gate arrays (FPGAs), and the like. In some examples, controller 405 may represent two or more controllers coupled as high availability (HA) pairs for at least fault tolerance and back-up purposes.

In various examples, controllers 405, 407, and 409 are configured to run an instance of a storage operating system to perform the I/O operations received from host 401. Controllers 405, 407, and 409 can perform I/O operations whereby the controllers determine a location at which to write data associated with an I/O operation on-the-fly based on metadata indicative of available storage. The controllers interface with host 401 via the application in accordance with a storage network and access protocol, such as Non-Volatile Memory Express (NVMe). Other protocols such as Network File System (NFS), Server Message Block protocol (SMB), Internet Small Computer System Interface (iSCSI), Fiber Channel (FC), Fiber Channel over Ethernet (FCoE), and the like may be contemplated. Controllers 405, 407, and 409 may further interface with the storage devices of Drive shelves 410, 420, and 430 over one of the network protocols at which the controllers perform the I/O operations.

Drive shelves 410, 420, and 430 are each representative of a group or array of storage devices physically in proximity relative to each other in a shelf or enclosure. Examples of the storage devices include flash disks and/or capacity drives, such as hard-disk drives (HDDs) and solid state drives (SSDs), as well as combinations and variations thereof. As illustrated in system 400, drive shelf 410 includes disks 411, 412, 413, 414, 415, and 419, drive shelf 420 includes disks 421, 422, 423, 424, 425, and 429, and drive shelf 430 includes disks 431, 432, 433, 434, 435, and 439 (all collectively referred to as disks or drives).

Drive shelves 410, 420, and 430 additionally include components to power the storage devices, connect drive shelves to a communication network, and the like. For example, drives shelves 410, 420, and 430 each include one or more power supplies, fans, interconnects, network equipment, and the like.

In some embodiments, system 400 may include additional or fewer drive shelves, and each drive shelf may include additional or fewer disks. Additionally, each drive shelf may be made up of one or more redundancy groups of storage devices (e.g. RAID groups), including several data disks and one or more parity disks that each provide redundancy for one another.

In various embodiments, each controller of system 400 interfaces with disks of drive shelves 410, 420, and 430 based on the shared-everything layout. In other words, controllers 405, 407, and 409 each have access to some or all of the disks, and provide I/O requests to the disks to write to or read from the disks of the drive shelves.

In various embodiments, the disks in each drive shelf are divided into allocation areas, such that each controller is allocated a specific location from which to read data and to which to write data. In particular, each allocation area corresponds to one of controllers 405, 407, and 409. For example, drive shelf 410 includes allocation areas 451, 453, 455, and 457, which include portions of storage within each of data disks 411, 412, 413, 414, and 415 of drive shelf 410. Allocation areas 451 and 455 are associated with controller 405, allocation area 453 are associated with controller 407, and allocation area 457 are associated with controller 409. Drive shelf 420 includes allocation areas 459 and 461. Allocation area 459 is associated with controller 407, and allocation area 461 is associated with controller 405. Drive shelf 430 includes allocation areas 463, 465, and 467. Allocation area 463 is associated with controller 405, allocation area 465 is associated with controller 407, and allocation area 467 is associated with controller 409. Additional or fewer allocation areas may be included in each group of disks, as well as combinations and variations thereof with respect to each controller of system 400.

In operation, each controller performs I/O operations and accesses respective allocation areas of the groups of disks based on the I/O operations. By way of example, for a write operation by controller 405 to disks of drive shelf 410, controller 405 writes user data to allocation area 451 at each disk of drive shelf 410 based on the write request.

Additionally, for the write operation, controller 405 generates metadata, replicates the metadata, and determines a primary location at which to store the metadata among the drives and a secondary location at which to store the replicated metadata among the drives that is a different physical location (e.g., a different drive shelf) than the primary location. The metadata may include information about the user data specified in the write request and information about where the user data is stored (e.g., the drive shelf, the disk(s), the allocation area). The metadata may also associate the user data with the particular write request.

The primary location represents a disk on a disk shelf used to store the primary copy of the metadata (e.g., one or more disks of drive shelf 410). The primary location includes a logical address of the primary disk, such as a logical address within an allocation area of the disk. The logical address is associated with the physical location of the primary disk, such as to which disk shelf the primary disk belongs. In various examples, identifying the primary location entails identifying an available logical address and identifying a disk associated with the logical address based on storage aggregate layout metadata (e.g., WAFL buffer tree).

The secondary location represents another disk on a disk shelf used to store the replicated, or redundant, copy of the metadata (e.g., one or more disks of either drive shelf 420 or drive shelf 430). The secondary location also includes a logical address of the secondary disk and an association of the logical address and the physical location of the secondary disk. In some examples, identifying the secondary location entails identifying another available logical address and identifying a disk associated with the logical address based on the storage aggregate layout metadata. In some examples, identifying the secondary location instead, or additionally, entails identifying an available logical address from a range of logical addresses that correspond to physical locations different from the physical location of the primary location.

In various examples, controller 405 determines the secondary location based on the primary location, or more specifically, based on the physical location of the primary location, such that replicated metadata is stored on a different drive shelf than the metadata. In various examples, this entails comparing the physical locations associated with the logical addresses of the primary and secondary locations for a match. If the physical locations match, then controller 405 determines the locations correspond to the same drive shelf, and controller 405 finds a different secondary location. If the physical locations do not match, then controller 405 determines the locations correspond to different drive shelves, and controller 405 proceeds to store the replicated metadata at the secondary location.

Advantageously, resiliency and robustness of a shared-everything data storage environment is enhanced as the whole storage aggregate might not fail despite a single drive shelf failure when metadata is protected and replicated across different shelves. Because each controller can access any storage device in such an architecture, other controllers can reconstruct a failed drive shelf by accessing the replicated metadata.

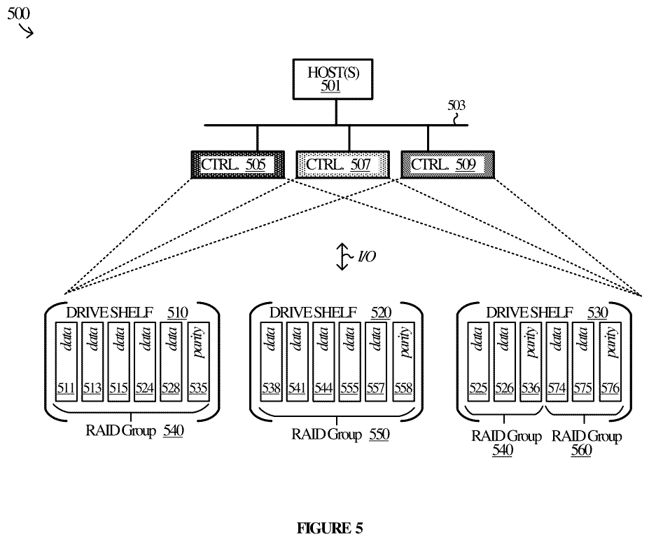

FIG. 5 illustrates an example data storage system in an implementation. FIG. 5 shows system 500, which includes host(s) 501, controllers 505, 507, and 509, and drive shelves 510, 520, and 530. Drive shelves 510, 520, and 530 may each include a plurality of storage devices arranged in redundancy groups, or RAID groups. In various embodiments, controllers 505, 507, and 509 may be configured to perform data storage and data replication processes, such as method of FIG. 2.

System 500 is representative of a data storage system operating in a data storage environment. System 500 includes multiple controllers and multiple storage devices (e.g., drives) arranged in a shared-everything architecture such that each of the controllers is capable of accessing any of the storage devices. In particular, controllers 505, 507, and 509 can perform input/output (I/O) operations (e.g., read operations, write operations) with all of the storage devices of drive shelves 510, 520, and 530.

Host(s) 501 (hereinafter referred to as host 501) is representative of one or more host servers, applications, devices, systems, or the like, capable of providing I/O operations to controllers 505, 507, and 509. Host 501 may include and may be implemented in hardware, software, and/or firmware, as well as combinations and variations thereof.

By way of example, host 501 is representative of a server running an application that interfaces with system 500 via network 503 to read from and write to the storage devices of system 500. An end user accesses host 501, or the application thereof, via a user device (e.g., a computer, a tablet, a smartphone), and provides requests to perform I/O operations via one of controllers 505, 507, or 509 to access the storage devices. Host 501 provides the I/O requests to controllers 505, 507, and/or 509, using an interface (e.g., a command line interface (CLI)) to the application over an application programming interface (API) (e.g., a RESTful API).

Controllers 505, 507, and 509 are representative of control devices or systems that each include one or more processing devices capable of controlling, managing, and accessing each of the storage devices of system 500. Examples of the processing devices may include one or more central processing units (CPUs), general purpose processors, Application Specific Integrated Circuits (ASICs), microcontroller units (MCUs), digital signal processors (DSPs), field-programmable gate arrays (FPGAs), and the like. In some examples, controller 505 may represent two or more controllers coupled as high availability (HA) pairs for at least fault tolerance and back-up purposes.

In various examples, controllers 505, 507, and 509 are configured to run an instance of a storage operating system to perform the I/O operations received from host 501. Controllers 505, 507, and 509 can perform I/O operations whereby the controllers determine a location at which to write data associated with an I/O operation on-the-fly based on metadata indicative of available storage. The controllers interface with host 501 via the application in accordance with a storage network and access protocol, such as Non-Volatile Memory Express (NVMe). Other protocols such as Network File System (NFS), Server Message Block protocol (SMB), Internet Small Computer System Interface (iSCSI), Fiber Channel (FC), Fiber Channel over Ethernet (FCoE), and the like may be contemplated. Controllers 505, 507, and 509 may further interface with the storage devices of Drive shelves 510, 520, and 530 over one of the network protocols at which the controllers perform the I/O operations.

Drive shelves 510, 520, and 530 are each representative of a group or array of storage devices physically in proximity relative to each other in a shelf or enclosure. Examples of the storage devices include flash disks and/or capacity drives, such as hard-disk drives (HDDs) and solid state drives (SSDs), as well as combinations and variations thereof. Each drive shelf may include one or more groups of disks that provide redundancy with respect to one another. Such groups are referred to as redundancy groups or RAID groups. Specifically, drive shelf 510 includes RAID group, drive shelf 520 includes RAID group 550, and drive shelf 530 includes RAID groups 540 and 560. RAID group 540 includes data disks 511, 513, 515, 524, and 528 located on drive shelf 510, data disks 525 and 526 located on drive shelf 530, parity disk 535 located on drive shelf 510, and parity disk 536 located on drive shelf 530. RAID group 550 includes data disks 538, 541, 544, 555, and 557 located on drive shelf 520, data disks 574 and 575 located on drive shelf 530, parity disk 558 located on drive shelf 520, and parity disk 576 located on drive shelf 530.

Drive shelves 510, 520, and 530 additionally include components to power the storage devices, connect drive shelves to a communication network, and the like. For example, drives shelves 510, 520, and 530 each include one or more power supplies, fans, interconnects, network equipment, and the like.

In some embodiments, system 500 may include additional or fewer drive shelves, and each drive shelf may include additional or fewer disks. Additionally, each drive shelf may include fewer or additional RAID groups, and each RAID group may include additional or fewer data disks and parity disks. Further, some RAID groups may span multiple drive shelves.

In various embodiments, each controller of system 500 interfaces with disks of drive shelves 510, 520, and 530 based on the shared-everything layout. In other words, controllers 505, 507, and 509 each have access to some or all of the disks, and provide I/O requests to the disks to write to or read from the disks of the drive shelves.

In operation, each controller performs I/O operations and accesses respective allocation areas of the groups of disks based on the I/O operations. By way of example, for a write operation by controller 505 to disks of RAID group 540 of drive shelf 510, controller 505 writes user data to data disks 511, 513, 515, 524, and 528 of RAID group 540, performs a parity operation (e.g., an XOR operation) to generate parity data, and stores parity data at parity disk 535 based on the write operation.

Additionally, for the write operation, controller 505 generates metadata, replicates the metadata, and determines a primary location at which to store the metadata among the drives and a secondary location at which to store the replicated metadata among the drives that is a different physical location (e.g., a different drive shelf) than the primary location. The metadata may include information about the user data specified in the write request and information about where the user data is stored (e.g., the drive shelf, the disk(s), the RAID group). The metadata may also associate the user data with the particular write request.

The primary location represents a disk(s) on a disk shelf used to store the primary copy of the metadata (e.g., one or more disks of a RAID group of drive shelf 510). The primary location includes a logical address of the primary disk, such as a logical address within of the disk(s). The logical address is associated with the physical location of the primary disk, such as to which disk shelf the primary disk belongs and to which RAID group the primary disk belongs. In various examples, identifying the primary location entails identifying an available logical address and identifying a disk associated with the logical address based on storage aggregate layout metadata (e.g., WAFL buffer tree).

The secondary location represents another disk(s) on a disk shelf used to store the replicated, or redundant, copy of the metadata (e.g., one or more disks of either drive shelf 520 or drive shelf 530). The secondary location also includes a logical address of the secondary disk and an association of the logical address and the physical location of the secondary disk. In some examples, identifying the secondary location entails identifying another available logical address and identifying a disk associated with the logical address based on the storage aggregate layout metadata. In some examples, identifying the secondary location instead, or additionally, entails identifying an available logical address from a range of logical addresses that correspond to physical locations different from the physical location of the primary location.

In various examples, controller 505 determines the secondary location based on the primary location, or more specifically, based on the physical location of the primary location and based on the RAID group of the primary location, such that replicated metadata is stored on a different drive shelf and in a different RAID group than the metadata. In various examples, this entails comparing the physical locations associated with the logical addresses of the primary and secondary locations for a match. If the physical locations match, then controller 505 determines the locations correspond to the same drive shelf, and controller 505 finds a different secondary location. If the physical locations do not match, then controller 505 determines the locations correspond to different drive shelves, and controller 505 proceeds to determine whether the locations are associated with the same RAID group. If the locations are associated with the same RAID group, controller 505 finds a different secondary location, but if the locations are associated with different RAID groups, controller 505 stores the replicated metadata at the secondary location.

FIG. 6 illustrates an example aspect of metadata 180 used in an implementation. FIG. 6 shows aspect 600, which includes various data structures that form an aggregate buffer tree usable by one or more controllers of a data storage system, such as by controller 105 of operating environment 100. In particular, aspect 600 includes metadata tree 605, replicated metadata tree 606, data block 618, replicated data block 628, and drive shelves 110 and 120.

Metadata tree 605 and replicated metadata tree 606 are representative of metadata (e.g., metadata 180) used by a controller to determine a primary location at which to store metadata corresponding to an I/O operation, and to determine a secondary location at which to store a replicated version of the metadata. Accordingly, metadata tree 605 and replicated metadata tree 606 include metadata indicative of the storage devices in a data storage system, a layout of the storage devices, states (e.g., available and unavailable (or, used and unused, respectively)) of the storage devices, files, data, and metadata stored on the storage devices, and locations thereof with respect to the storage devices.

Referring first to metadata tree 605, aggregate volume information 610 includes metadata related to the storage aggregate of the data storage system (i.e., all the storage devices among the drive shelves in the data storage environment). More specifically, aggregate volume information 610 includes metadata related to drive shelf 110, drive shelf 120, and each of the disks thereof. For example, such metadata indicates an overall storage capacity of the storage aggregate, an available capacity of the storage aggregate, performance characteristics of the storage aggregate, a layout or configuration of the storage aggregate, including physical locations of each of the drive shelf, physical locations of the disks in each drive shelf, and a sequence of the disks in each drive shelf, and the like.

Aggregate file system information 612 includes metadata related to states of the storage aggregate and block-level information of the storage aggregate. For example, aggregate file system information 612 includes metadata related to a layout of data blocks (e.g., direct data blocks (e.g., data block 618, data block 628), indirect data blocks), including how the data blocks are structured. where the data blocks are located, which blocks are available (or unused), and which blocks are unavailable (or used). Thus, aggregate file system information 612 can be used to handle space allocation for write requests to ensure logical and physical space within the storage aggregate is managed and optimized across the pool of storage devices in the data storage environment.

Inode file information 614 includes metadata related to files and other storage objects stored in the disks of the storage aggregate. For example, inode file information 614 includes metadata related to file sizes, permissions (i.e., who can read/write the file), timestamps, and a list of pointers to blocks that hold the data that make up the files or indirect blocks that include other pointers that point to blocks that hold the data. As such, inode file information 614 allows the controller to track locations of both data and metadata blocks for files within the storage aggregate.

In various examples, inode file information 614 includes physical volume block number (PVBN) information associated with the storage aggregate. A PVBN may correspond to a physical location of a storage device. For large files or objects, a PVBN includes a reference to an indirect block (L1) that further references a direct block (L0) where actual data is stored. Importantly, the PVBNs indicated in inode file information 614 may be organized in a way where a first PVBN (P1) is listed in an index first, and a protected PVBN (P1′) that corresponds to a secondary location at which replicated metadata is stored is listed immediately after the first PVBN. In this way, primary locations storing primary copies of metadata and secondary locations storing secondary, replicated copies of the metadata can be looked up quickly in the index given their proximity in the index.

Container file information 616 includes metadata related to container files used to store different data structures, such as volume data, snapshot data, and metadata. The volume data refers to a container file that holds all the data blocks for a particular volume of storage, the snapshot data refers to a container file that stores data relative to a point-in-time, and the metadata refers to data block maps, inode files, and the like. In some examples, container file information 616 is referred to as an L1 block, or an indirect block, which includes information about the actual data blocks (also referred to as an L0 block, or direct block) that contain the file content or data, such as data block 618.

Replicated metadata tree 606 includes replicated versions of aggregate volume information 610, aggregate file system information 612, inode file information 614, and container file information 616. Specifically, replicated metadata tree 606 includes aggregate volume information 620 duplicative of aggregate volume information 610, aggregate file system information 622 duplicative of aggregate file system information 612, inode file information 624 duplicative of inode file information 614, and container file information 626 duplicative of container file information 616.

In addition to replicating metadata tree 605 to create replicated metadata tree 606, metadata is replicated across metadata tree 605 and replicated metadata tree 606, such that metadata tree 605 includes metadata from replicated metadata tree 606, and replicated metadata tree 606 includes metadata from metadata tree 605. In particular, inode file information 614 may include metadata associated with container file information 616 (i.e., an indirect block) as well as metadata associated with container file information 626 (i.e., a replicated version of the indirect block). Similarly, inode file information 624 includes metadata associated with container file information 626 as well as metadata associated with container file information 616. Also, container file information 616 and container file information 626 both include metadata related to data block 618 and data block 628.

Data block 618 includes file contents or data referenced in container file information 616 and 626. Data block 618 may correspond to one or more disks of drive shelf 110, and in particular, to one or more logical and/or physical addresses of the disks of drive shelf 110. Similarly, data block 628 includes file contents or data referenced in container file information 616 and 626. Data block 628 may correspond to one or more disks of drive shelf 120, and in particular, to one or more logical and/or physical addresses of the disks of drive shelf 120.

Based on the structure of the metadata trees, a controller can store a file, and/or metadata thereof, in blocks of drive shelf 110, while also storing a replicated version of the file, and/or the metadata thereof, in blocks of drive shelf 120. The controller can determine where to store each copy, and can track the locations thereof, based on metadata tree 605 and replicated metadata tree 606 for at least resiliency, redundancy, and recovery purposes.

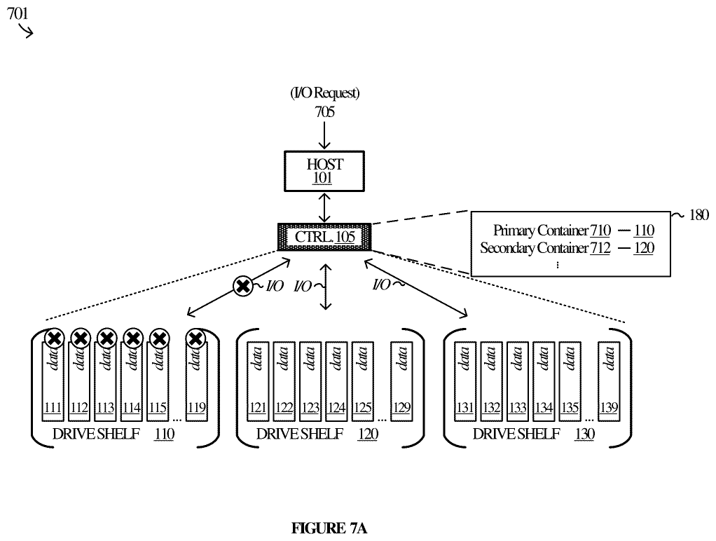

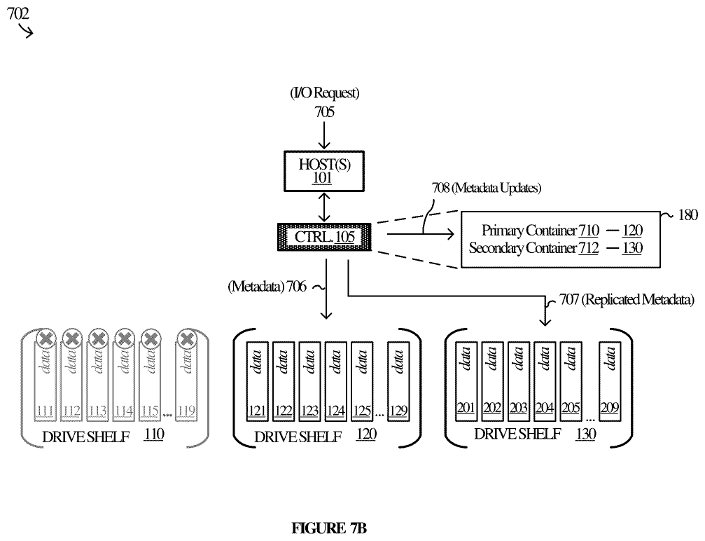

FIGS. 7A and 7B illustrate operating environments 701 and 702, respectively, in which storage devices in a drive shelf of a data storage system fail. Operating environments 701 and 702 both include computing device 101, controller 105, and drive shelves 110, 120, and 130, each of which include multiple storage devices.

In operating environment 701 of FIG. 7A, computing device 101 receives I/O request 705 corresponding to an I/O operation to be performed by controller 105. By way of example, I/O request 705 indicates a write operation and data to be written by controller 105 to disks 111, 112, 113, 114, 115, and 119 of drive shelf 110. Controller 105 receives I/O request 705 from computing device 101 and performs the write operation at the disks of drive shelf 110.

However, in operating environment 701, drive shelf 110 has failed, and thus, disks 111, 112, 113, 114, 115, and 119 are unavailable for access by controller 105. Based on the failure of drive shelf 110, none of the disks return an acknowledgement to controller 105 based on the attempt to write data to the disks. After a duration, controller 105 identifies that drive shelf 110 has failed based on the failure to receive an acknowledgement.

In operating environment 702 of FIG. 7B, controller 105 makes metadata updates 708 to metadata 180 upon determining that drive shelf 110 has failed. In various examples, metadata update 708 includes updates to layout metadata corresponding to a layout of the disks and drive shelves, and updates to index metadata corresponding to a file index of the disks, files stored thereon, metadata stored thereon, and replicated metadata stored thereon as well as other disks storing primary versions of the metadata that was replicated.

By way of example, in operating environment 701, metadata 180 indicates that disks of drive shelf 110 are the primary container 710 with respect to some metadata (e.g., metadata 706), while disks of drive shelf 120 are secondary container 720 with respect to replicated versions of that metadata (e.g., replicated metadata 707). In other words, in the context of operating environment 701, upon generating metadata 706 for a particular I/O operation, controller 105 selects a disk of drive shelf 110 to store a primary copy of the metadata 706 and a disk of drive shelf 120 to store a secondary, replicated copy of the metadata (replicated metadata 707).

Based on metadata updates 708, metadata 180 reflects an update to change the primary container 710 of the metadata to drive shelf 120 and secondary container 712 of the replicated versions of the metadata to drive shelf 130. In updating metadata 180, when controller 105 generates metadata for I/O request 705 after the failure of drive shelf 110, controller 105 identifies drive shelf 120 as the primary location at which to store metadata 706 and drive shelf 130 as the secondary location at which to store replicated metadata 707.

In various examples, metadata 180 includes further correlations between primary containers and secondary containers with respect to the storage of metadata and replicated versions thereof. In some examples, metadata 180 further specifies correlations between each drive and/or particular address(es) or ranges of addresses thereof. As such, controller 105 can identify locations across different drive shelves at which to store metadata 706 and replicated metadata 707 to ensure resiliency of the metadata and integrity of the storage aggregate.

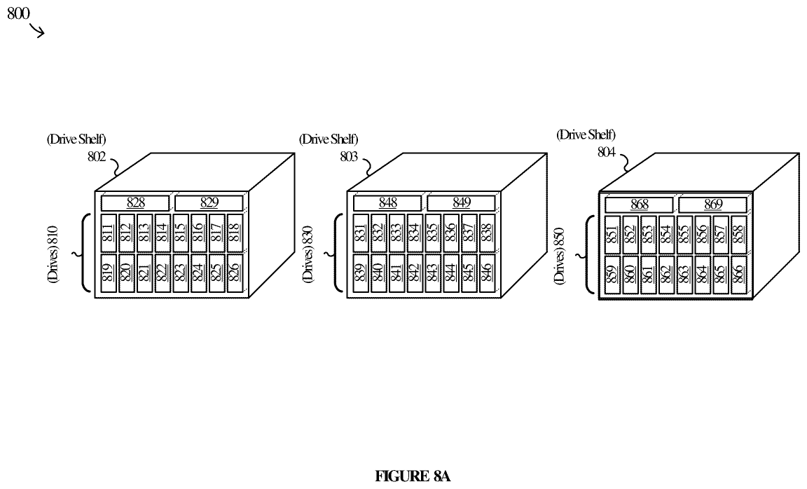

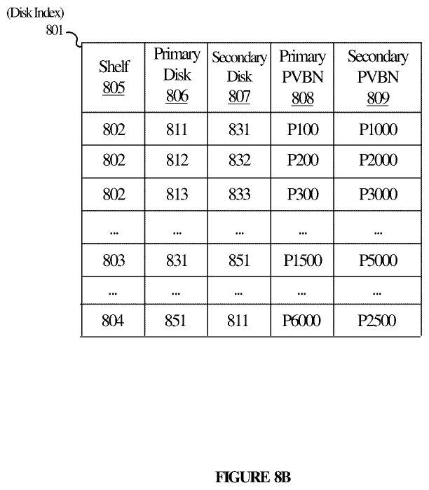

FIG. 8A illustrates an example data storage environment including representations of enclosures that hold various storage devices in an implementation. FIG. 8A shows operating environment 800, which includes drive shelves 802, 803, and 804, which include drives 810, 830, and 850, respectively, as well as other elements.

Drive shelves 802, 803, and 804 are representative of shelves, racks, or other enclosures that physically hold or contain numerous drives capable of storing data and metadata, which are accessible and managed by one or more controllers in the data storage environment (e.g., controller 105). In particular, drive shelf 802 includes drives 810, power supply 828, and interconnect 829, drive shelf 803 includes drives 830, power supply 848, and interconnect 849, and drive shelf 804 includes drives 850, power supply 868, and interconnect 869.

Drives 810 include drives 811-826, drives 830 include drives 831-846, and drives 850 include drives 851-866, each of which is representative of a storage device, such as a hard-disk drive (HDD), a solid-state drive (SSD), or another type of storage device capable of storing information.

Power supplies 828, 848, and 868 are representative of power management and power supply devices or systems capable of powering each of the drives in a respective shelf and powering a respective interconnect, among other electrical components in the shelves. Each drive in a respective shelf may be coupled to a power supply to provide storage functionality.

Interconnects 829, 849, and 869 are representative of network and interface devices or system that allow respective drives to communicate with one or more controllers in the data storage environment. Each drive in a respective shelf may be coupled to an interconnect to provide management and network connectivity functionality.

In various examples, each drive shelf includes a single redundancy group formed among the drives in the drive shelf. For example, drives 810 form a first redundancy group (e.g., RAID group) where drives 811-826 include several data drives and one or more parity drives. In this arrangement, each drive provides redundancy to one another. In some examples, each drive shelf may include additional redundancy groups. In some examples, some redundancy groups may be split among drive shelves.

In some examples, each drive shelf may include additional or fewer drives. Furthermore, the data storage environment represented by operating environment 800 may include additional or fewer drive shelves. Irrespective of the number of drive shelves and drives, controllers in communication with the drives can store metadata on one or more drives of a drive shelf and replicated versions of the metadata on one or more drives of a different drive shelf (and of a different redundancy group) to improve data recovery and data resiliency capabilities of operating environment 800. An example mapping of primary locations and corresponding secondary locations is illustrated in FIG. 8B.

FIG. 8B illustrates an example metadata table used in an implementation to store metadata and replicated versions of metadata across different drive shelves. FIG. 8B shows disk index 801, which includes a metadata mapping between shelf 805, primary disk 806, secondary disk 807, primary physical volume block number (PVBN) 808 and secondary PVBN 809.

In disk index 801, shelf 805 indicates a shelf on which a drive is located, such as drive shelf 802, drive shelf 803, or drive shelf 804. Primary disk 806 indicates a drive of a drive shelf corresponding to a primary location at which to store metadata for a corresponding I/O request. Secondary disk 807 indicates a different drive of a different drive shelf corresponding to a secondary location at which to store a replicated version of the metadata for the corresponding I/O request. Primary PVBN 808 indicates an address associated with the primary disk, and secondary PVBN 809 indicates an address associated with the secondary disk.

By way of example, address P100 of drive 811 located on drive shelf 802 is listed as the primary location for storage of a primary copy of metadata for an I/O operation, while address P1000 of drive 831 located on drive shelf 803 is listed as the secondary location for storage of a secondary, replicated copy of the metadata for the I/O operation. Following this example, upon receiving a request to perform an I/O operation, a controller in the data storage environment generates metadata corresponding to the I/O operation, identifies a primary location at which to store the metadata, and identifies a secondary location at which to store replicated metadata. To identify the primary and secondary locations, the controller can read disk index 801, identify the primary location based on primary disk 806 and primary PVBN 808, then select the secondary location based on secondary disk 807 and secondary PVBN 809 corresponding to the identified primary location.

It may be appreciated that developing strategies to mitigate the impact of data loss and disruption of requests to access data and corresponding storage devices due to storage device management processes has become important for enterprises and end users. Failures of storage devices, updates or upgrades to storage devices, and/or failures of controllers with which to manage such storage devices may occur and interrupt access to data.

To mitigate the downtime and disruption introduced when performing storage device upgrades, rebuilds, replacements, and the like, enterprises may utilize various systems, methods, and devices as described herein to manage data management systems, clusters thereof, nodes thereof, and RAID groups including various storage devices (e.g., disks), as well as data and metadata thereof.

The disclosure describes systems, methods, and devices for managing storage devices, the layout thereof in a data storage environment, the data and metadata stored therein, and managing access to the storage devices, and the like in shared-everything data storage system architectures, as well as for at least: 1) storing metadata and replicated versions of metadata across different drive shelves to enhance redundancy of metadata for the storage aggregate; 2) storing user data and replicated versions of user data across different drive shelves to enhance redundancy of user data for the storage aggregate; 3) storing metadata and/or user data as well as replicated versions thereof across different RAID groups to enhance redundancy of the data for the storage aggregate; and 4) tracking metadata of indirect and direct blocks at the drive shelf-level to ensure cross-shelf storage of data for the storage aggregate.

Various embodiments of the present technology provide for a wide range of technical effects, advantages, and/or improvements to computing systems and components. For example, various embodiments may include one or more of the following technical effects, advantages, and/or improvements: 1) management of access to storage devices; 2) non-disruptive access to storage devices; 3) management of storage devices and RAID groups of storage devices; 4) management of user data and metadata corresponding to storage devices; 5) redundancy of user data and metadata in case of drive shelf failure; 6) scalable controllers and storage devices in a distributed shared-everything architecture; 7) scalable RAID group layouts; and 8) ability to protect against and reconcile updates to storage devices, and metadata thereof, from multiple controllers.

FIG. 9 illustrates computing system 901, which is representative of any system or collection of systems in which the various applications, processes, services, and scenarios disclosed herein may be implemented. Examples of computing system 901 include, but are not limited to server computers, web servers, cloud computing platforms, and data center equipment, as well as any other type of physical or virtual server machine, container, and any variation or combination thereof. (In some examples, computing system 901 may also be representative of desktop and laptop computers, tablet computers, smartphones, and the like.)

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements data replication process 906, which is representative of the processes discussed with respect to the preceding Figures. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may include a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, microcontroller units, graphical processing units, application specific processors, integrated circuits, application specific integrated circuits, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 903 may be implemented as a single storage device but may also be implemented across multiple storage devices or sub-systems co-located or distributed relative to each other. Storage system 903 may comprise additional elements, such as a controller capable of communicating with processing system 902 or possibly other systems.

Software 905 (including data replication process 906) may be implemented in program instructions and among other functions may, when executed by processing system 902, direct processing system 902 to operate as described with respect to the various operational scenarios, sequences, and processes illustrated herein. For example, software 905 may include program instructions for implementing data storage management, replication, and recovery processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer-readable storage media; and
program instructions stored on the one or more computer-readable storage media executable by a processing device that, based on being read and executed by the processing device, direct the processing device to:
receive a write request corresponding to user data to be stored in a storage aggregate of a data storage environment;
generate metadata associated with the write request;
identify a primary location at which to store the metadata, wherein primary location comprises a logical address associated with a physical location on a first shelf of the data storage environment;
identify a secondary location at which to store a replicated version of the metadata, wherein the secondary location comprises a logical address associated with a physical location on a second shelf of the data storage environment that differs from the first shelf; and
store the metadata and the replicated version of the metadata using respective logical addresses.

2. The computing apparatus of claim 1, wherein to identify the secondary location, the program instructions direct the processing device to:
identify the logical address of the secondary location;
confirm the logical address of the secondary location is associated with a physical location on a shelf different from the first shelf; and
responsive to confirming the logical address is associated with the physical location on the second shelf that differs from the first shelf, determine the secondary location.

3. The computing apparatus of claim 1, wherein the program instructions further direct the processing device to:
receive a read request corresponding to the user data stored in the storage aggregate;
identify the primary location at which the metadata is stored;
read the metadata at the primary location to determine a location at which the user data is stored in the storage aggregate; and
read the user data from the location.

4. The computing apparatus of claim 3, wherein the program instructions further direct the processing device to:
identify a failure of the first shelf based on attempting to read the metadata at the primary location;
responsive to identifying the failure of the first shelf, identify the secondary location at which the replicated version of the metadata is stored;
read the replicated version of the metadata at the secondary location to determine the location at which the user data is stored in the storage aggregate; and
read the user data from the location.

5. The computing apparatus of claim 4, wherein the program instructions further direct the processing device to:
responsive to identifying the failure of the first shelf, identify a location at which to store the replicated version of the metadata; and
store the replicated version of the metadata at a logical address of the location.

6. The computing apparatus of claim 5, wherein the location and the corresponding logical address are associated with a physical location on a third shelf of the data storage environment that differs from the first and second shelves.

7. The computing apparatus of claim 5, wherein the location and the corresponding logical address are associated with the physical location on the first shelf following recovery of the first shelf.

8. The computing apparatus of claim 1, wherein:
the data storage environment comprises the storage aggregate that includes the multiple drives, and multiple controllers capable of communicating with each of the drives;
the first shelf comprises a first subset of the drives and a first set of components, including a first power supply and a first interconnect, coupled to the first subset of the drives; and
the second shelf comprises a second subset of the drives and a second set of components, including a second power supply and a second interconnect, coupled to the second subset of the drives.

9. The computing apparatus of claim 8, wherein the logical address of the primary location is associated with a first redundancy group of drives on the first shelf that provide redundancy with respect to each other, and wherein the logical address of the secondary location is associated with a second redundancy group of drives on the second shelf different from the first redundancy group that provide redundancy with respect to each other.

10. The computing apparatus of claim 1, wherein to program instructions further direct the processing device to store a replicated version of the user data at the secondary location using the logical address associated with the physical location on the second shelf.

11. One or more non-transitory computer-readable storage media having stored thereon program instructions executable by one or more processors of a data storage environment comprising a storage aggregate that includes multiple drives, and one or more controllers capable of communicating with each of the drives in the storage aggregate, that, when executed by the one or more processors, direct the one or more processors to:
receive a write request corresponding to user data to be stored in a storage aggregate of a data storage environment;
generate metadata associated with the write request;
identify a primary location at which to store the metadata, wherein primary location comprises a logical address associated with a physical location on a first shelf of the data storage environment;
identify a secondary location at which to store a replicated version of the metadata, wherein the secondary location comprises a logical address associated with a physical location on a second shelf of the data storage environment that differs from the first shelf; and
store the metadata and the replicated version of the metadata using respective logical addresses.

12. The one or more non-transitory computer-readable storage media of claim 11, wherein to identify the secondary location, the program instructions direct the one or more processors to:
identify the logical address of the secondary location;
confirm the logical address of the secondary location is associated with a physical location on a shelf different from the first shelf; and
responsive to confirming the logical address is associated with the physical location on the second shelf that differs from the first shelf, determine the secondary location.

13. The one or more non-transitory computer-readable storage media of claim 11, wherein the program instructions further direct the one or more processors to:
receive a read request corresponding to the user data stored in the storage aggregate;
identify the primary location at which the metadata is stored;
read the metadata at the primary location to determine a location at which the user data is stored in the storage aggregate; and
read the user data from the location.

14. The one or more non-transitory computer-readable storage media of claim 13, wherein the program instructions further direct the one or more processors to:
identify a failure of the first shelf based on attempting to read the metadata at the primary location;
responsive to identifying the failure of the first shelf, identify the secondary location at which the replicated version of the metadata is stored;
read the replicated version of the metadata at the secondary location to determine the location at which the user data is stored in the storage aggregate; and
read the user data from the location.

15. The one or more non-transitory computer-readable storage media of claim 14, wherein the program instructions further direct the one or more processors to:
responsive to identifying the failure of the first shelf, identify a location at which to store the replicated version of the metadata; and
store the replicated version of the metadata at a logical address of the location.

16. The one or more non-transitory computer-readable storage media of claim 15, wherein the location and the corresponding logical address are associated with either a physical location on a third shelf of the data storage environment that differs from the first and second shelves or the physical location on the first shelf following recovery of the first shelf.

17. The one or more non-transitory computer-readable storage media of claim 11, wherein to program instructions further direct the processing device to store a replicated version of the user data at the secondary location using the logical address associated with the physical location on the second shelf.

18. The one or more non-transitory computer-readable storage media of claim 11, wherein:
the data storage environment comprises the storage aggregate that includes the multiple drives, and multiple controllers capable of communicating with each of the drives;
the first shelf comprises a first subset of the drives and a first set of components, including a first power supply and a first interconnect, coupled to the first subset of the drives; and
the second shelf comprises a second subset of the drives and a second set of components, including a second power supply and a second interconnect, coupled to the second subset of the drives.

19. The one or more non-transitory computer-readable storage media of claim 18, wherein the logical address of the primary location is associated with a first redundancy group of drives on the first shelf that provide redundancy with respect to each other, and wherein the logical address of the secondary location is associated with a second redundancy group of drives on the second shelf different from the first redundancy group that provide redundancy with respect to each other.

20. A method executed by one or more processors, comprising:
generating metadata associated with a write request received for writing data in a storage system having a first shelf with a first set of storage devices and a second shelf having a second set of storage devices different from the first set storage devices;
identifying a primary location to store the metadata, wherein primary location comprises a logical address associated with a physical location on a first shelf;
identifying a secondary location to store a replicated version of the metadata, wherein the secondary location comprises a logical address associated with a physical location on the second shelf ; and
storing the metadata and the replicated version of the metadata using respective logical addresses.

21. The method of claim 20, wherein identifying the secondary location comprises:
identifying the logical address of the secondary location;
confirming the logical address of the secondary location is associated with a physical location on a shelf different from the first shelf; and
responsive to confirming the logical address is associated with the physical location on the second shelf that differs from the first shelf, determining the secondary location.

22. The method of claim 21 further comprising:
receiving a read request corresponding to the data stored in the storage system;
identifying the primary location at which the metadata is stored;
reading the metadata at the primary location to determine a location at which the data is stored; and
reading the data from the location.

23. The method of claim 22 further comprising:
identifying a failure of the first shelf based on an attempt to read the metadata at the primary location;
responsive to identifying the failure of the first shelf, identifying the secondary location at which the replicated version of the metadata is stored;
reading the replicated version of the metadata at the secondary location to determine the location at which the data is stored; and
reading the data from the location.

24. The method of claim 23 further comprising:
responsive to identifying the failure of the first shelf, identifying a location to store the replicated version of the metadata; and
storing the replicated version of the metadata at a logical address of the location.

25. The method of claim 24, wherein the location and the corresponding logical address are associated with either a physical location on a third shelf of the storage system that differs from the first and second shelves or the physical location on the first shelf following recovery of the first shelf.

26. The method of claim 20 further comprising storing a replicated version of the user data at the secondary location using the logical address associated with the physical location on the second shelf.

27. The method of claim 20, wherein the logical address of the primary location is associated with a first redundancy group of storage devices on the first shelf that provide redundancy with respect to each other, and wherein the logical address of the secondary location is associated with a second redundancy group of storage devices on the second shelf different from the first redundancy group that provide redundancy with respect to each other.
